(19) United States
(12) Patent Application Publication
(10) Pub. No.: US 2007/0215212 A1
(43) Pub. Date: Sep. 20, 2007

(54) Floor drain with incorporated flood prevention

(76) Inventor: Michael A. Demeniuk, Shelby Township, MI (US)

Correspondence Address: HARNESS, DICKEY & PIERCE, P.L.C., P.O. BOX 828, BLOOMFIELD HILLS, MI, 48303, US

(21) Appl. No.: 11/376,687

(22) Filed: Mar. 15, 2006

(51) Int. Cl. F16L 5/00

(52) U.S. Cl. 137/362

(57) ABSTRACT

A floor drain assembly with integrated flood prevention, comprising a unitary construction which may be retrofitted into existing floor drain plumbing without modification to the plumbing or surrounding floor. The floor drain assembly comprises an integrated check valve, which under normal circumstances remains open, allowing spilled or poured liquids to drain through the assembly into the sewer plumbing. In an event such as storm flooding or sewage water back up, the water level within the pipe will exert buoyant force upon the check valve, causing it bias against a sealing means, thereby preventing liquid and sewage waste from rising up through the pipe opening and entering a building, causing flooding.

### FIELD OF THE INVENTION

The present invention relates to floor drains for residential, commercial, and industrial applications. More particularly, this present invention relates to floor drains which incorporate features preventing backflow and subsequent flooding.

### BACKGROUND OF THE INVENTION

Virtually every new and old commercial, residential, and industrial building constructed is equipped with a sewage system comprising a series of plumbing conduits which serve to deliver liquid waste from various locations throughout a building to a centralized drain. The main drain is generally located below the lowest point in a sewage system, usually below the basement or foundation, and transports liquid waste out to the municipal collection system or to a septic field.

In the event that a storm causes the ground-water level to rise, oftentimes the waste levels in the municipal sewers also rise, wherein the liquid will try to escape from the lowest point possible; very often this is the floor drains of basements. If the water rises significantly, these floor drains may overflow, causing flooding of a basement and significant water damage to a building and its contents.

Various means of preventing this phenomenon from occurring have been implemented throughout the prior art. One such means comprises implementing a check valve into a drain, which allows drainage through a pipe under normal conditions, but prevents the liquid waste from rising during flooding scenarios and entering a building. The check valve systems of the art up until now have either incorporated multiple components requiring assembly prior to their use, major drain pipe modifications, or even floor modification for their implementation. This can be costly both for installation and/or repair in the event the valve becomes damaged and needs to be replaced.

Therefore, an easy-to-implement floor drain with a flooding-prevention means is needed in the art, which does not require modification of existing plumbing or the surrounding floor and is simple to install and economic to manufacture.

### SUMMARY OF THE INVENTION

It is, therefore, an object of the present invention to provide a floor drain with a check valve preventing undesirable sewer drainage from backing up into a building, causing flooding.

It is another object of the present invention to provide a floor drain with a flood-prevention means which can be incorporated into existing plumbing without modification of the pipes or surrounding flooring.

Another object of the present invention is to provide a floor drain with flood prevention which is simple and economical to manufacture.

A further object of the present invention is to provide a floor drain with a flood-prevention means which can be manufactured to any size plumbing gauge.

Another object of the present invention is to provide a drain assembly with a flood-prevention means which is installed as a single element without the need to assemble a plurality of parts.

Lastly, it is an object of the present invention to provide a floor drain with a flood-prevention means suitable for installation in either slip-fit or threaded-plumbing fittings.

These and other objectives will be more clearly understood from the detailed description and figures contained herein relating to a floor drain assembly having an incorporated flood-prevention means which is installed in the floor drain of a home or business with little or no modification to the existing plumbing or mounting surface. The drain assembly can be manufactured from either PVC, ABS, or any other suitable material, and comprises a cylindrical insert which may either be slip fitted or threaded into the drain pipe located in a floor. A generally-planar drain plate, attached to the upper end of the cylindrical insert, comprises a plurality of intermittently-spaced wide and narrow ribs covering the upper end of the drain assembly and provides openings therebetween for liquids or fluids to drain into the drain pipe. The drain plate further provides a mounting flange for attaching the drain assembly to the floor surrounding the drain pipe when installed and may be manufactured to be integrated with the cylindrical insert as a unitary apparatus.

The cylindrical drain insert comprises a tapered lower end which is positioned within the drain pipe opening. A check valve having a coated float material of circular shape is slidably attached to the drain plate by a slide pin located through a central aperture in the plate. The check valve further comprises a tapered upper surface which is complementary to the tapered lower end of the drain insert.

In the normal at-rest disposition, the check valve is in its lowered, open position due to gravity, allowing liquids to flow through the drain plate and between the tapered lowered end of the cylindrical insert and the upper surface of the float material. In the undesirable event that the level of liquid within the drain begins to rise, the float material of the check valve will rise, as well, in response thereto to the point wherein the upper surface of the check valve will seal against the tapered lower end of the cylindrical drain insert, preventing backup liquid from entering a building through the drain opening.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an overhead view of a preferred embodiment of a floor drain assembly with flood-prevention means of the present invention;

FIG. 2 is a cross-sectional, side-view of a floor drain assembly in the open disposition, taken along line 2 of FIG. 1;

FIG. 3 is a cross-sectional, side-view of a floor drain assembly in the open disposition, taken along line 3 of FIG. 1;

FIG. 4 is a cross-sectional, side-view of a floor drain assembly in the closed disposition, due to the raised level of liquid within a drain pipe;

FIG. 5 is an overhead view of a further embodiment of a floor drain assembly with flood-prevention means of the present invention; and

FIG. 6 is a cross-sectional, side-view of a floor drain assembly, taken along line 6 of FIG. 5.

### DETAILED DESCRIPTION OF THE PREFERRED EMBODIMENTS

The following description of the preferred embodiments is merely exemplary in nature and is in no way intended to limit the invention, its application, or uses.

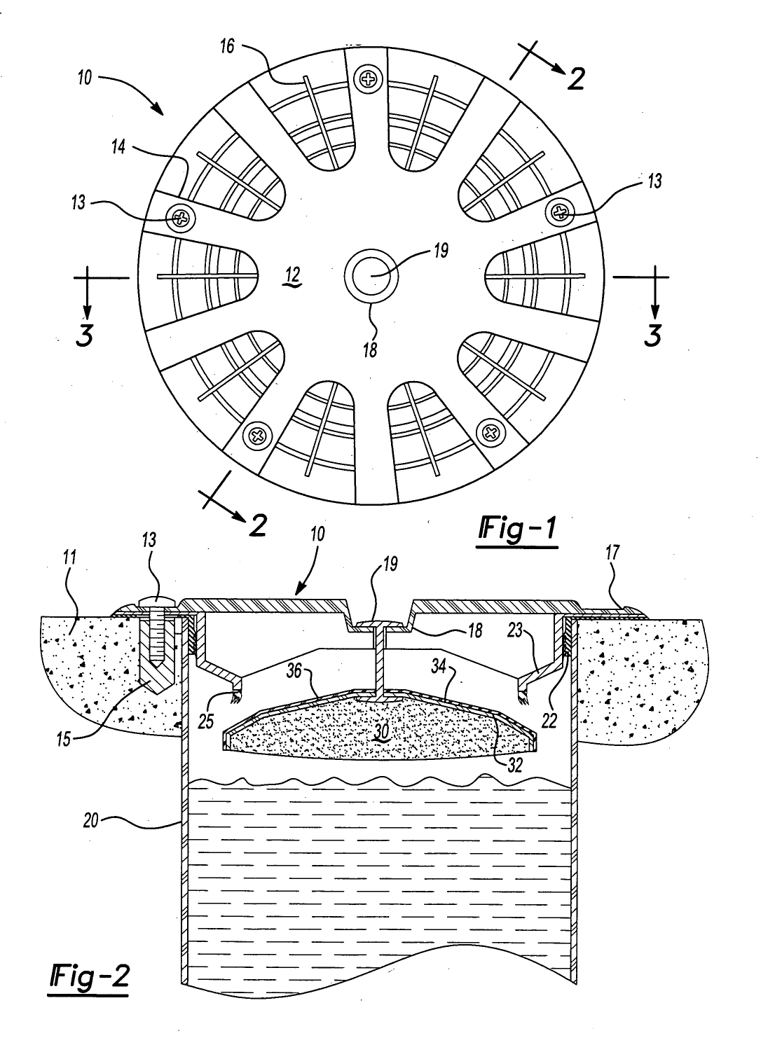

With reference to the drawings, wherein like-reference numerals designate like or corresponding parts throughout, there is shown in FIGS. 1-3 a first embodiment of a floor drain assembly 10 comprising the present invention. Floor drain assembly 10 is manufactured from either PVC, ABS, or any other suitable material and comprises a generally-circular drain plate 12 having a plurality of intermittently-spaced wide spokes 14 and narrow spokes 16 projecting outwardly from the center thereof. Spokes 14 and 16 are supported in the outer periphery by one or more integrated circular ribs and define a plurality of apertures therebetween through which liquids may be passed into drainage system pipes 20 of a building. Positioned on the outer periphery of one or more wide spokes is a plurality of apertures for receiving mounting screws 13. The preferred invention comprises ten wide spokes 14 and ten narrow spokes 16, but virtually any variation in spoke design and numeration is intended to be within the scope of the present invention.

As illustrated in FIGS. 2 through 4, drain plate 12 is incorporated with a generally-cylindrical insert 24 having an outside diameter corresponding with the inside diameter of drain pipe 20 in which it is being retrofitted. Some of the more common drain pipe 20 sizes utilized in drain systems for buildings include 1″, 1.5″, 2″, 2.5″, 3″, 4″, 5″, 6″, 7″, 8″, 9″, 10″, 11″, and 12,″ but the present drain assembly can be manufactured to fit virtually any size slip-fit or threaded drain opening as shown in FIG. 4 and is, therefore, not intended to be a limiting aspect of the present invention. A silicone, butyl, or rubber seal 22 may be positioned around the outside of the cylindrical insert, forming a seal between existing pipe 20 and assembly 10.

Cylindrical insert 24 further comprises an inward tapered lower end 23, with a sealing means 25 located on the lower periphery thereof, which forms the sealing surface which interacts with a check valve 30. Sealing means 25 of insert 24 may comprise either a triple seal or a bulb seal and is continuous around the lower end of the cylindrical insert.

Drain plate 12 as shown in FIGS. 2 through 4 has a diameter greater than the outside diameter of drain pipe 20, forming a mounting flange 17 positioned around the drain assembly. It is within wide spokes 14 of mounting flange 17 through which mounting screws 13 are inserted and fastened to anchors 15 placed in a floor 11 surrounding drain pipe 20. A rubber, butyl or silicone seal may also be located between flange 17 of drain plate 12 and floor 11 and, when installed, the drain plate creates little or no relief above the planar surface of building floor 11.

Check valve 30 comprises a generally-circular, disc-shaped element having a diameter equal to or greater than the tapered lower end 23 of cylindrical insert 24, but less than the inside diameter of existing building pipe 20. The valve may be manufactured from any number of buoyant materials, alone or in combination, including but not limited to Styrofoam, cork, wood, plastic, expanded polystyrene, ABS plastic or PVC, and may further comprise either a solid element or a sealed, air-filled element. In a further embodiment, check valve 30 comprises a plastic core 32 surrounding a buoyant material and having a rubber coating 36 covering the upper surface thereof for increased sealing of the check valve when in its closed disposition.

Check valve 30 is attached to a central slide pin 19, which extends upward from the valve and is slidably received through an aperture in the center of drain plate 12, terminating with an upper flange having a diameter greater than the aperture in plate 12, preventing pin 19 and valve 30 from separating from drain assembly 10. In the preferred embodiment, a recess 18 is molded in drain plate 12, surrounding the slide pin. This feature assures that when valve 30 is in the closed (raised) orientation, pin 19 still remains flush or slightly recessed below the plane of drain plate 12, preventing damage from incidental impacts from objects or people.

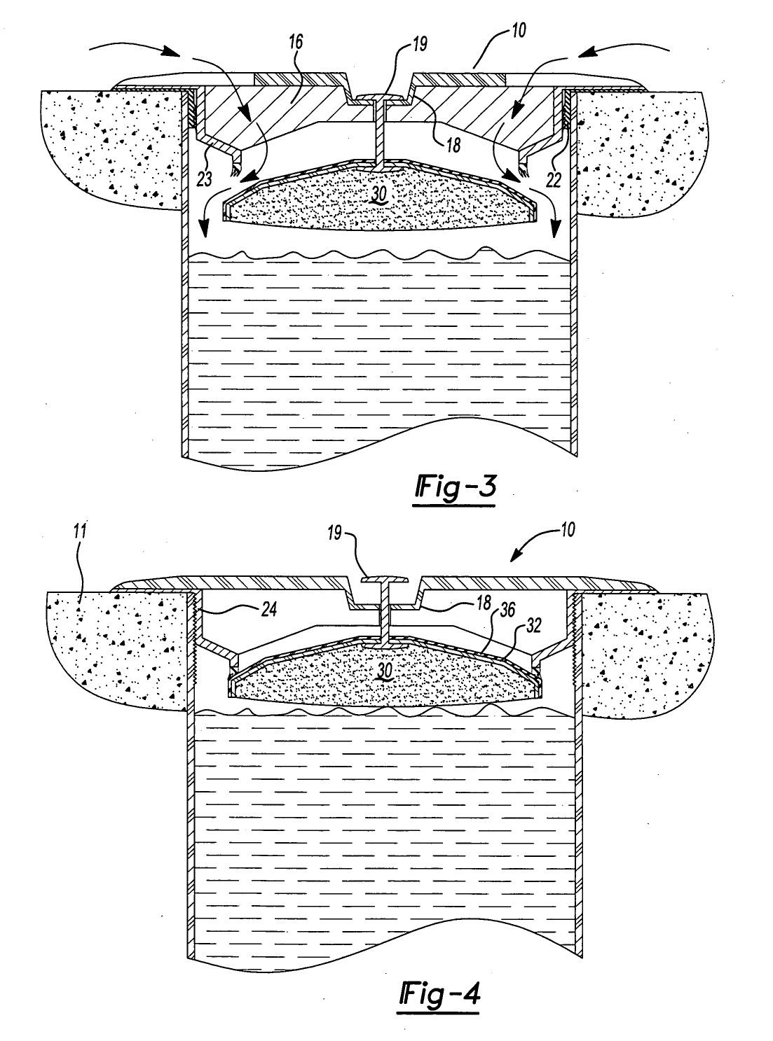

Once installed, assembly 10 remains in the open orientation as shown in FIGS. 2 and 3, so long as the water level within pipe 20 is below the float valve. In this disposition, liquid and fluid which may be spilled or poured down the drain are free to enter the spaces between spokes 14, 16, travel down the cylindrical insert, and flow out between sealing means 25 of tapered lowered end 23 and the upper surface of check valve 30 into the drain.

In the event such as storm flooding or sewage water back up as illustrated in FIG. 4, the water level within pipe 20 may begin to rise. If it continues to rise, it will exert buoyant force upon check valve 30, causing it and slide pin 19 to rise. If the water level rises enough, the upper beveled surface of check valve 30 will be biased against sealing means 25 of tapered lower end 23 of cylindrical insert 24, sealing off the drain. Once sealed in this manner, backed-up liquid and sewage waste is prevented from rising up through the pipe opening and entering a building, causing flooding.

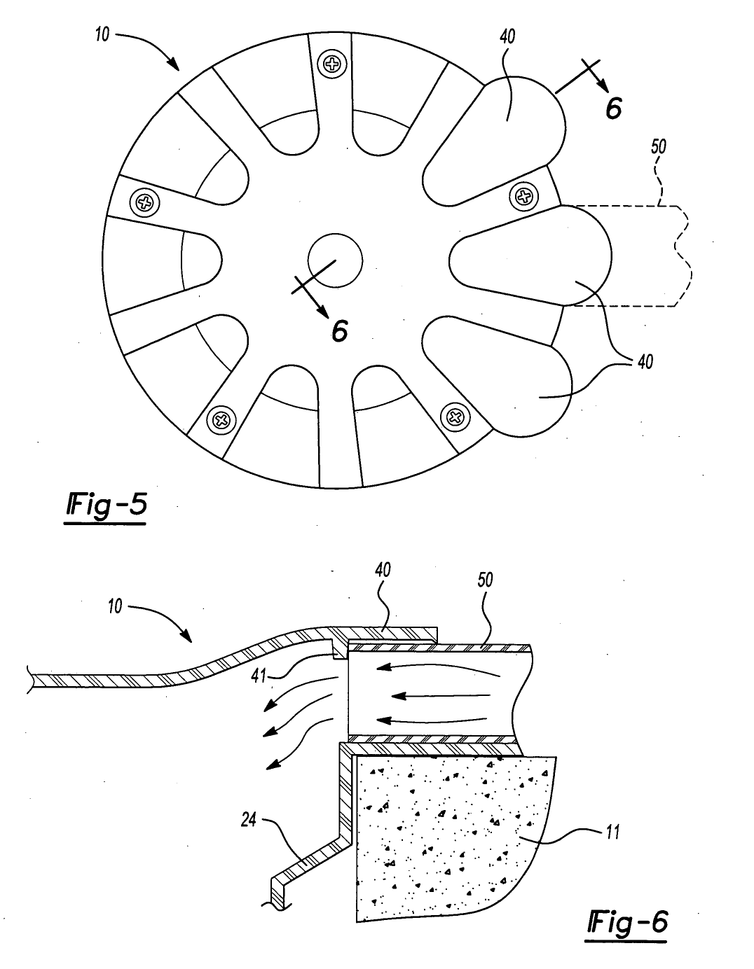

Referring now to FIGS. 5 and 6, a further embodiment of present drain assembly 10 is shown. This embodiment provides a means for one or more drain pipes 50 to be directly connected to the check valve/drain assembly, such as from dehumidifiers, furnaces, water heaters, washing machines and the like. This embodiment comprises a modified drain plate which comprises one or more integrated pipe couplings 40 integrated into the top of the plate above the floor surface and extending out parallel to floor 11. The couplings can be manufactured to receive any number of common-sized-diameter drainage pipes from various appliances and does not interfere with the normal operation of the check valve or normal draining operations of floor drain assembly 10.

Pipe couplings 40 comprise a stop means 41 positioned within the drain plate, preventing pipe 50 from being inserted too far, and provide for an alternative to the common practice of simply inserting the appliance drain hose 50 down a drain opening. Furthermore, the advantages and objects described above, which prevent backflow and flooding from a sewer system, further protect any appliance drain pipes from damage from a similar flooding scenario.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A floor drain insert with incorporated flood-prevention means for attaching to an existing slip-fit floor drain pipe comprising:
a generally-planar screening grate having a plurality of outwardly-projecting spokes of alternating wide and narrow widths defining a plurality of apertures therebetween;
a collar attached to a bottom side of said screening grate, said collar having a first diameter slightly less than the inside diameter of said floor drain pipe, being partially received within said floor drain pipe, said collar extending downwards a predetermined distance before tapering inwards radially at a lower end, said lower end having a diameter less than first diameter of said collar; said screening grate extending radially outward a predetermined distance beyond said collar forming a mounting flange wherein said apertures between the wide and narrow spokes are within the diameter of said collar;
said flood-prevention means comprising a disc-shaped check valve manufactured of a buoyant material, said check valve having a tapered upper perimeter for associating with said lower end of said collar; said check valve being attached to an upwardly-projecting pin extending upwardly through a central aperture in said screening grate, terminating in an upper flange, said flange having a diameter greater than said central aperture of said screening grate;
wherein said pin is slidably received through said central aperture, and having a length which allows said check valve to be moved from a first lowered position wherein the tapered upper perimeter of said check valve is separated from the lower end of said collar, to a second, raised position wherein the tapered upper perimeter of the check valve is sealingly abutting the lower end of said collar, said second raised position imposed by the buoyancy force of liquid level within the drain pipe rising against said check valve.

2. The floor drain insert with incorporated flood-prevention means of claim 1, wherein when said check valve is in said first lowered position, liquid is allowed to flow through said screening grate, through said collar, and between said lower end of said collar and over said check valve, down said floor drain.

3. The floor drain insert with incorporated flood-prevention means of claim 1, having a slip-fit collar diameter receivable in an existing drain pipe having an inside diameter chosen from one of the following: 1″, 1.25″, 1.5″, 2″, 2.5″, 3″, 4″, 5″, 6″, 7″, 8″, 9″, 10″, 11″, and 12″.

4. The floor drain insert with incorporated flood-prevention means of claim 1, wherein said flange of said screening grate has a plurality of apertures around the outer periphery, through which mounting hardware is received to attach said floor drain insert to the floor surrounding said existing drain pipe.

5. The floor drain insert with incorporated flood-prevention means of claim 1, wherein said central aperture of said screening grate is recessed within said insert, wherein when said check valve is in said second raised position, the upper flange of said pin remains flush with the screening grate.

6. The floor drain insert,with incorporated flood-prevention means of claim 1, wherein said buoyant material of said check valve comprises at least one of the following materials: Styrofoam, cork, wood, plastic, expanded polystyrene, ABS plastic, or PVC.

7. The floor drain insert of claim 6, wherein said check valve comprises a solid element.

8. The floor drain insert of claim 6, wherein said check valve comprises a sealed, air-filled element.

9. The floor drain insert with incorporated flood-prevention means of claim 1, further providing at least one means of connecting a secondary drain pipe from one or more of the following: dehumidifier, furnace, water heater, washing machine, or hose.

10. The floor drain insert with incorporated flood-prevention means of claim 1, wherein said check valve further comprises a seal attached to said upper tapered perimeter.

11. The floor drain insert with incorporated flood-prevention means of claim 1, further comprising a sealing means around the lower end of said collar.

12. The floor drain insert with incorporated flood-prevention means of claim 1, further comprising a sealing means between said flange of said screening grate and the floor surrounding said drain pipe.

13. The floor drain insert with incorporated flood-prevention means of claim 12, further comprising a sealing means between the first diameter of said collar and the inside of said existing drain pipe.

14. The floor drain insert with incorporated flood-prevention means of claim 13, wherein said sealing means between said screening grate and the floor and said sealing means between the first diameter of said collar and the inside of said existing drain pipe are a single element.

15. The floor drain insert with incorporated flood-prevention means of claim 1, wherein said insert is installed as a single assembled piece.

16. The floor drain insert with incorporated flood-prevention means of claim 1, wherein said screening grate and said collar are manufactured from at least one of the following materials: PVC, ABS, or Polycarbonate.

17. A floor drain insert with incorporated flood-prevention means for attaching to an existing, internally-threaded floor drain pipe comprising:
a generally-planar screening grate having a plurality of outwardly-projecting spokes of alternating wide and narrow widths defining a plurality of apertures therebetween;
a collar attached to a bottom side of said screening grate, said collar having a first diameter comprising a threaded outer surface corresponding to said threaded floor drain pipe, being partially received within said floor drain pipe, said collar extending downwards a predetermined distance before tapering inwards radially at a lower end, said lower end having a diameter less than first diameter of said collar; said screening grate extending radially outward a predetermined distance beyond said collar forming a mounting flange wherein said apertures between the wide and narrow spokes are within the diameter of said collar;
said flood-prevention means comprising a disc-shaped check valve manufactured of a buoyant material, said check valve having a tapered upper perimeter for associating with said lower end of said collar; said check valve being attached to an upwardly-projecting pin extending upwardly through a central aperture in said screening grate, terminating in an upper flange, said flange having a diameter greater than said central aperture of said screening grate;
wherein said pin is slidably received through said central aperture, and having a length which allows said check valve to be moved from a first lowered position wherein the tapered upper perimeter of said check valve is separated from the lower end of said collar, to a second, raised position wherein the tapered upper perimeter of the check valve is sealingly abutting the lower end of said collar, said second raised position imposed by the buoyancy force of liquid level within the drain pipe rising against said check valve.

18. The floor drain insert with incorporated flood-prevention means of claim 17, wherein when said check valve is in said first lowered position, liquid is allowed to flow through said screening grate, through said collar, and between said lower end of said collar and over said check valve, down said floor drain.

19. The floor drain insert with incorporated flood-prevention means of claim 17, having a collar diameter receivable in an existing drain pipe having an inside diameter chosen from one of the following: 1″, 1.25″, 1.5″, 2″, 2.5″, 3″, 4″, 5″, 6″, 7″, 8″, 9″, 10″, 11″, or 12″.

20. The floor drain insert with incorporated flood-prevention means of claim 17, wherein said flange of said screening grate has a plurality of apertures around the outer periphery, through which mounting hardware is received to attach said floor drain insert to the floor surrounding said existing drain pipe.

21. The floor drain insert with incorporated flood-prevention means of claim 17, wherein said central aperture of said screening grate is recessed within said insert, wherein when said check valve is in said second raised position, the upper flange of said pin remains flush with the screening grate.

22. The floor drain insert with incorporated flood-prevention means of claim 17, wherein said buoyant material of said check valve comprises at least one of the following materials: Styrofoam, cork, wood, plastic, expanded polystyrene, ABS plastic, or PVC.

23. The floor drain insert of claim 22, wherein said check valve comprises a solid element.

24. The floor drain insert of claim 22, wherein said check valve comprises a sealed, air-filled element.

25. The floor drain insert with incorporated flood-prevention means of claim 17, further providing at least one means of connecting a secondary drain pipe from one or more of the following: dehumidifier, furnace, water heater, washing machine, or hose.

26. The floor drain insert with incorporated flood-prevention means of claim 17, wherein said check valve further comprises a seal attached to said upper tapered perimeter.

27. The floor drain insert with incorporated flood-prevention means of claim 17, further comprising a sealing means around the lower end of said collar.

28. The floor drain insert with incorporated flood-prevention means of claim 17, further comprising a sealing means between said flange of said screening grate and the floor surrounding said drain pipe.

30. The floor drain insert with incorporated flood-prevention means of claim 17, wherein said insert is installed as a single assembled piece.

31. The floor drain insert with incorporated flood-prevention means of claim 17, wherein said screening grate and said collar are manufactured from at least one of the following materials: PVC, ABS, or Polycarbonate.
